(19) United States
(12) Patent Application Publication
(10) Pub. No.: US 2007/0240802 A1
(43) Pub. Date: Oct. 18, 2007

(54) Run-flat tire having multiple chambers

(75) Inventor: Kyle S. Smith, Springdale, AR (US)

Correspondence Address: Kyle Smith, 2462 Orchard Street, Springdale, AR, 72764, US

(73) Assignee: Kyle S. Smith, Springdale, AR (US)

(21) Appl. No.: 11/733,768

(22) Filed: Apr. 11, 2007

Related U.S. Application Data
(60) Provisional application No. 60/745,002, filed on Apr. 17, 2006.

(51) Int. Cl. B60C 17/00

(52) U.S. Cl. 152/339.1; 152/516

(57) ABSTRACT

A tire consisting of a tread, two exterior sidewalls, and a plurality of interior support walls mounted to a rim and/or a run-flat support ring which provides for at least three pressure zones inside the tire. These differing zones provide multiple run-flat stages reducing the likelihood of complete pressure loss when the tire is punctured. These pressure zones also provide for the contact patch to be adjusted to the current driving conditions. When mounted to a vehicle where camber changes during cornering, these differing air zones provide for an extended contact patch during cornering by exchanging air pressure between the inside shoulder and the outside shoulder of the tire.

### CROSS-REFERENCE TO RELATED APPLICATIONS

This application claims the benefit of PPA Ser. No. 60/745,002, filed 2006 Apr. 17 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to run-flat tires having multiple chambers.

2. Background of the Invention

Throughout the history of the pneumatic tire, the vehicles that used them have been left stranded at some point from punctures or other incidents that cause a drop in pressure and removing the ability of the tire to function correctly. Originally, people would have to simply stop their vehicle and repair the tire or remove it and replace it with another tire. This was very time consuming and in many cases dangerous to the vehicle operator and passengers.

Thereafter, inventors created many different designs trying to solve these problems. Run-Flat tires were designed to overcome the need to immediately replace the tire or repair the damaged tire. These provide the ability to operate the vehicle at low speeds and for a short distance allowing the operator to move the vehicle to a safe area to replace or fix the damaged tire.

Although these designs did provide a solution to the problem they are not ideal. The current run-flat designs require the vehicle to be operated at below normal highway speeds and thus creating a dangerous operating environment. The distance that the current run-flat designs allow are limited as well since the tire, while operable, is still highly stressed beyond its reasonable operating range. Current run-flat designs also compromise the ride comfort of the operator and passengers since they utilize stiffer side walls to handle the highly stressed operations encountered during run-flat conditions.

### OBJECTS AND ADVANTAGES

Accordingly, besides the objects and advantages of the run-flat tires described in my above patent, several objects and advantages of the present invention are:
(a) to provide a run-flat tire that has broader capabilities and longer range to that of conventional run-flat tire designs.
(b) to provide a run-flat tire that can have side walls made of softer compounds thus providing a more comfortable ride while providing increased lateral and comparable vertical support to a conventional run-flat tire.
(c) to provide a run-flat tire that can maintain a higher level of performance under all conditions to that of a conventional run-flat tire.
(d) to provide a run-flat tire that has multiple run-flat phases.
(e) to provide a run-flat tire that has a customizable contact patch.
(f) to provide a run-flat tire that has an extending contact patch when the camber of the tire changes during operation.
Still further objects and advantages will become apparent from a consideration of the ensuing description and drawings.

### SUMMARY

In accordance with the present invention a run-flat tire comprises a tire having two sidewalls with at least two additional interior support walls that mount to either a run-flat support ring or a modified rim design.

### DRAWINGS—FIGURES

FIG. 1 shows various cross sectional views of the tire mounted to a rim with a run-flat ring.

FIG. 2 shows the tire mounted to a rim without the run-flat ring.

FIG. 3 shows a side view of the run-flat ring showing the air channels.

FIG. 4 shows a cross section view of the tire only.

### DRAWINGS—REFERENCE NUMERALS

| | |
|---|---|
| 1, 2 | sidewalls |
| 3 | tread |
| 4, 5 | interior support walls |
| 6 | run-flat support ring |
| 7, 8 | bead seats |
| 9 | air channels |

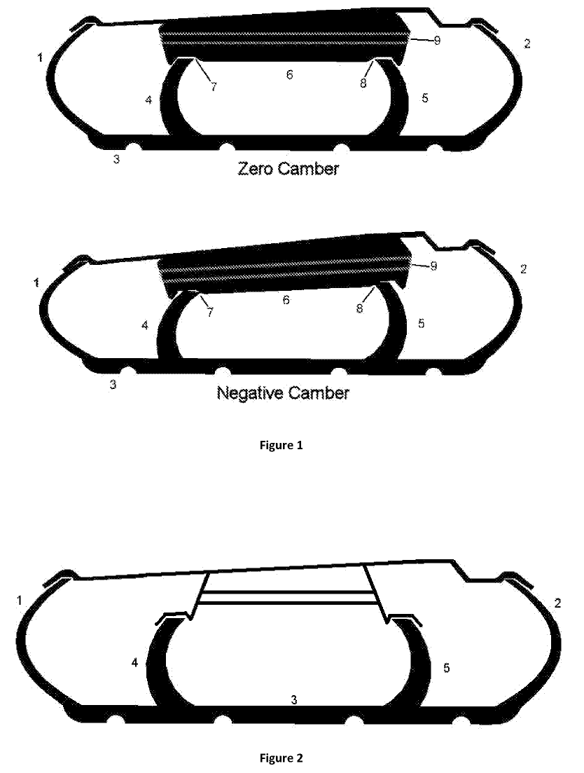

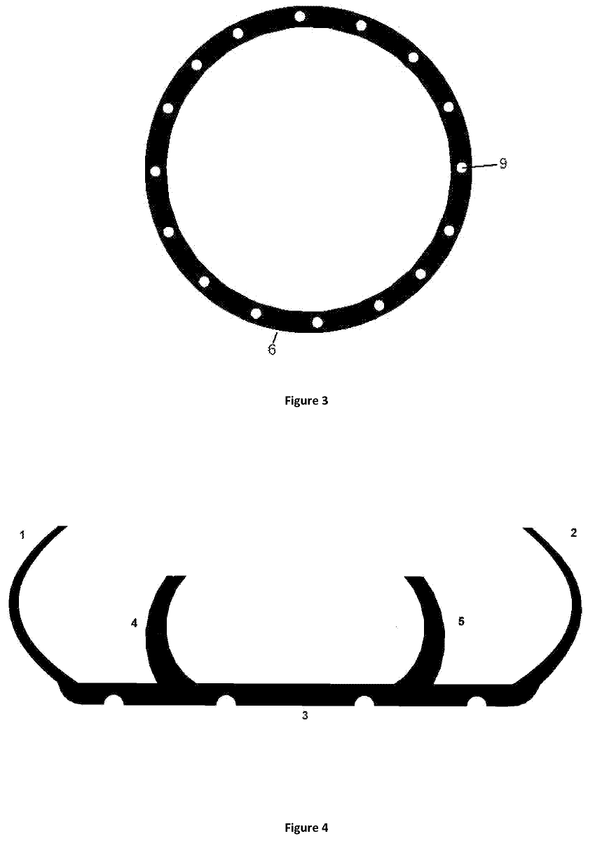

### DETAILED DESCRIPTION—FIG. 1 PREFERRED EMBODIMENT

A preferred embodiment of the tire of the present invention is illustrated in FIG. 1. The tire has a plurality of interior support walls. The ideal structure of this invention contains the tread, two exterior sidewalls, and two interior support walls. This will provide a total of four support walls and three air zones. The exterior support walls mount to a rim like a conventional tire. The interior support walls, in the preferred embodiment, are mounted to a support ring having bead seats. The support ring must be mounted to the rim and must have horizontal channels that allow the passage of air between the two outer air zones.

### FIG. 2 ADDITIONAL EMBODIMENT

An additional embodiment is shown in FIG. 2. In FIG. 2 the interior support walls are mounted to a rim design having an integrated support structure that is comparable in design and function to the support ring mentioned above.

### OPERATION

This design consists of a tire having two sidewalls with at least two additional interior support walls that mount to either a run-flat support ring or a modified rim design. Including the tire's sidewalls, there is ideally a total of four support walls creating three air pressure zones. The middle zone is completely isolated from the outer zones. The outer zones are linked by transferring air through channels in the sides of a run-flat support ring or a wheel rim providing the same. During situations that induce camber in the tire (FIG. 1), the pressure zone on the inside of the camber angle reduces in volume and the air passes through the channels mentioned previously to the pressure zone on the outside of the camber angle. This increases the volume in the outside pressure zone and forces the tread of the tire to remain in contact with the road. The middle air pressure zone provides a fulcrum point for this to occur. If it doesn't exist, as in a conventional tire design, there is a single air pressure zone and the air volume will be evenly distributed across the tire. During a similar situation that induces camber in a tire with only one air zone, the tread will not be pushed down on the outside of the camber angle, but will lift progressively and reduce the contact patch. It is the middle zone that provides the fulcrum point that is the key to this invention working as intended during variable camber conditions. These three air zones also provide three levels of run-flat operation. If the central air zone is punctured the two outer zones maintain their pressure and the integrity of the tire. With either of the two outer zones punctured, the central zone maintains its pressure and the integrity of the tire. With both the central and outer zones punctured, the support ring and added rigidity of having ideally four support walls maintain the integrity of the tire.

### CONCLUSION, RAMIFICATIONS, AND SCOPE

Thus the reader will see that the run-flat tire of this invention provides increased levels of safety and performance while maintaining a comfortable ride, provides a longer range than conventional run-flat tires, provides increased lateral support, and provides a customizable contact patch. In addition, because of its unique multiple chamber design, it has at least three run-flat stages providing the operator the ability to drive at normal motorway speeds which will allow for moving the vehicle to a safer location to repair the tire. As well, the operator can adapt the tire to their current needs by changing the contact patch by means of changing the inner and outer pressure zones of the tire.

I claim:

1. A tubeless, pneumatic tire for a vehicle wheel,
Comprising:
(a) a carcass; and
(b) a support ring,
(c) wherein the carcass further comprises a tread portion, two axially-opposite side walls and a plurality of interior support walls,
(d) wherein the support ring further comprises recessed portions located axially that provide bead seats,
(e) wherein the support ring further comprises horizontal channels that allow air passage,
(f) wherein the axially-opposite side walls have a bead mountable to a rim of a wheel,
(g) wherein the interior support walls have a bead mountable to a bead seat provided.
